(19) United States
(12) Patent Application Publication
(10) Pub. No.: US 2008/0134519 A1
(43) Pub. Date: Jun. 12, 2008

(54) EATING UTENSIL

(76) Inventors: Elisabeth Lawlor, Annapolis, MD (US); Elisabeth Bauer, Fort Myers, FL (US)

Correspondence Address: MILORD & ASSOCIATES, P.C., 10880 WILSHIRE BOULEVARD, SUITE 2070, LOS ANGELES, CA, 90024, US

(21) Appl. No.: 11/609,839

(22) Filed: Dec. 12, 2006

(51) Int. Cl. B26B 11/00

(52) U.S. Cl. 30/142

(57) ABSTRACT

A utensil used in eating that allows ergonomic grasp thereof by a variety of users having varying sized hands. The handle region may be looped in one preferred embodiment to accommodate the fingers of a user there through. In an alternate preferred embodiment, the handle region is elongated and only one end is connected to the planar region.

### FIELD OF THE INVENTION

The invention relates to utensils in general and, more particularly, to the art of an ergonomically designed eating utensil that allows a user to push food onto another utensil and may provide a sharp edge for cutting food before pushing the same.

### BACKGROUND OF THE INVENTION

Numerous eating utensils are known in the art, the most common of which, are the fork and knife. However, knives that are commonly used do not allow for an ergonomic fit into the hand of a user. In addition, knives cannot be easily used at a variety of angles to reach certain portions of a serving dish. Numerous attempts have been made to provide substitutes for knives to be used in eating.

For instance, U.S. Pat. No. 2,940,634 to Wild discloses an eating aid for use on food retaining plates. The device is comprised of a thin sheet of plastic material which forms a baffle adapted to clip to the rim of a plate. Mounted food can be moved against the baffle, which facilitates the gathering of food where a fork or spoon can be pushed under it.

U.S. Pat. No. 3,734,306 to Moorewood discloses a self-feeding device which is operated by an electric motor. The device is comprised of several tubular arms and means with which a feeding implement is disposed at an angel of less than 180 with respect to a dish so that food from the dish can be pushed, by a wand onto the feeding implement. The device is energized through a switch adapted to be activated by a wand attached to a handicapped operator who need only be able to control the motion of his head and neck.

U.S. Pat. No. 4,159,839 to Sigler discloses an implement of tableware adapted to work in conjunction with conventional silverware to clear all food from the plate. The implement comprises a bowl head having a front scooped, pushing surface, peripherally defined by variously contoured scraping edges, and a handle attached to the rear of the bowl head. The contoured edges serve as scrapers. At least one edge is flat to maximally contact the surface of a flat plate, and at least one other edge is curved to maximally conform to the rounded bottom surface of cups and bowls.

U.S. Pat. No. 4,229,880 to Brooks, et al. discloses a combined eating utensil which is usable as a holder or pusher to accumulate food on a plate, a blocking member that can be used in conjunction with other utensils to remove food from the plate, and as a knife. The patent discloses an eating utensil having a surface that can be either moved along the top of a plate to accumulate food positioned on the plate or placed in a blocking position on the plate, and a second surface that can be used as a knife.

U.S. Pat. No. 5,588,551 to Morrow, et al. discloses an eating device for aiding persons to eat when they only have the use of one hand. The object of the invention is to provide an eating aid which is a stop against which a person can push food with an eating utensil, thereby making it easier to get the food onto the utensil without the need to use a second utensil in a second hand.

U.S. Pat. No. 5,774,921 to Harrison, et al. discloses a toothbrush or other utensil specifically designed for use by toddlers and small children providing a handle in the form of an animal figure having a body to scale. An object of the invention is to provide the toothbrush or other utensil with a handle that is easily held and sufficiently large to prevent swallowing of the utensil by a small child.

U.S. Pat. No. 6,105,254 to Crane, et al. discloses a spoon with scissors like handles which are pivotally connected to each other at approximately their midpoints. An object of the invention is to provide hand held eating utensil of a novel construction which allows for the interaction of the user with the decorative and functional animal figures of the spoon.

U.S. Pat. No. 6,141,815 to Harrison, et al. discloses a toothbrush or other utensil specifically designed for use by toddlers and small children providing a handle in the form of an animal figure having a body which is essentially to scale. The handle carries either a rearwardly extending tail or forwardly extending trunk or other singular symmetrical limb. A toothbrush head or other operative utensil portion is secured to the limb, tail or trunk. The shaft of the utensil can include a spring-loaded locking member to that it is detachably removable from a base of the handle.

U.S. Pat. No. 6,363,568 to Harrison, et al. discloses a toothbrush or other utensil specifically designed for use by toddlers and small children proving a handle in the form of an animal figure having a body, which is essentially to scale. The handle carries either a rearwardly extending tail or forwardly extending trunk or other singular symmetrical limb. The body includes appendages, such as legs, that allow it to stand stably upon a planar surface with the operative utensil portion supported off of the surface. The shaft of the utensil can include a spring-loaded locking member so that it is detachably removable from a base of the handle.

The prior art does not address the need for a utensil that is adapted to ergonomically fit within the hands of a variety of users. In addition, the prior art fails to provide a utensil that can be used at a variety of angles depending upon the position of the food in a serving dish. Other disadvantages of the prior art will become apparent from the reading of the following specification and claims. Therefore, there remains a long standing and continuing need for an advance in the art of eating utensils, which shortcomings are addressed by the instant invention.

### SUMMARY OF THE INVENTION

In keeping with the principles of the present invention, a unique utensil device is disclosed wherein the device is capable of use by a variety of users having a wide range of hand sizes in an ergonomic manner. In addition, by providing a substantially rigid body, the device is durable and cost efficient to manufacture.

One aspect of a preferred embodiment of the utensil, has a substantially looped handle region to allow grasping thereof at a variety of points along the handle region, which in turn allows a user to grip the handle at a most comfortable position. The looped handle region may also have varying thicknesses along the length thereof to further provide various grip alternatives to a user. The looped handle region also allows use of the utensil at varying angles to reach foods in a variety of serving dishes.

Another aspect of an alternate preferred embodiment is to provide an elongated handle region that may also have a varying thickness along the length thereof to further provide various grip alternatives to a user. In one preferred embodiment, the handle region rests in the first dorsal web space and is enclosed by a users thumb and fingers. The handle region is curved to allow for ergonomic engagement with the hand of the user and the handle region may be rotated within the hand of the user such that a second, third, and fourth edge of the utensil may contact the serving surface.

Another aspect of the invention is to provide a tapered edge to contact the serving surface such that the edge may be used to cut food products. In addition, the edge may be serrated to provide further ability in cutting the food product.

Such stated summary of preferred embodiments of the invention are only examples and should not be construed as limiting the present invention. These and other features, aspects, and advantages of the invention herein will become more apparent from the following detailed description of the preferred embodiments of the invention when taken in conjunction with the accompanying drawings and the claims that follow.

### BRIEF DESCRIPTION OF THE DRAWINGS

It is to be understood that the drawings are to be used for the purposes of setting forth preferred embodiments of the invention via illustration only and not as a definition of the limits of the invention. In the drawings, wherein similar reference characters denote similar elements throughout the several views:

FIG. 1 is a side elevational vies of the utensil.

FIG. 2 is a side elevational view of an alternate preferred embodiment of the utensil.

FIG. 3 is a cross-sectional view of the utensil device taken along line 3-3 of FIG. 1.

FIG. 4 is a side elevational view of an alternate preferred embodiment of the utensil.

### DETAILED DESCRIPTION OF THE INVENTION

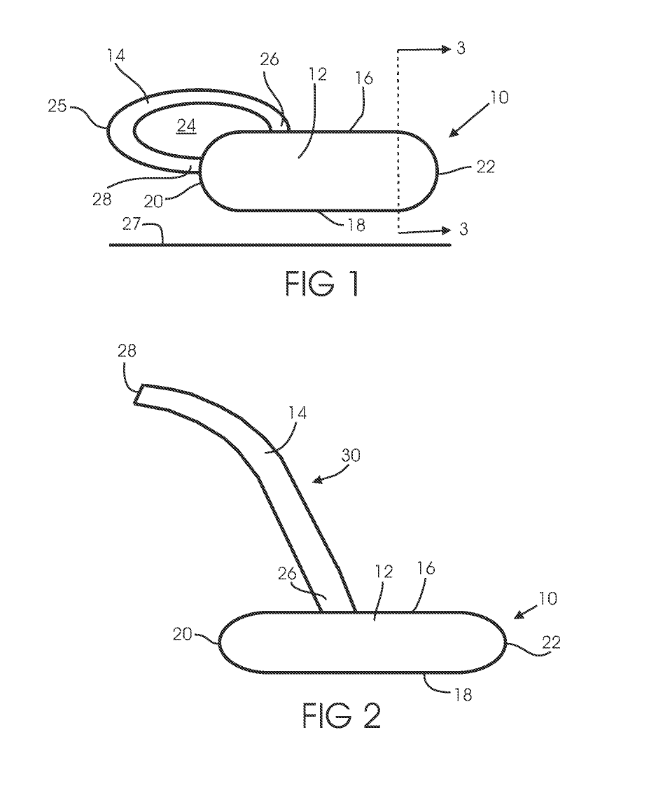

Referring now to the FIG. 1, a preferred embodiment of an eating utensil generally designated by reference numeral 10 is illustrated. Eating utensil 10 is made of plastic and is preferably injection molded in one piece, however, it is to be understood that other manufacturing methods known in the art may also be employed. For purposes of illustration, but not limitation, eating utensil 10 may be formed of two separate parts of plastic that are sonic welded. Furthermore, eating utensil 10 may be made of metal, wood or any other rigid material that is heat resistant. Eating utensil 10 has a substantially planar region 12 and a handle region 14 extending therefrom. Handle region 14 is ergonomically designed to fit within a wide range of users' hand sizes such that the planar region 12 maintains contact with a serving dish.

Planar region 12 has a first edge 16 and an opposing second edge 18 which are interconnected by a third edge 20 and a fourth edge 22, which third 20 and fourth 22 edges are distal to one another. Handle region 14, in one preferred embodiment, extends from first edge 16 to third edge 20 in a substantially oval-shape and is tubular in cross-section whereby an opening 24 is created to accommodate fingers of a user in an ergonomic manner such that handle region 14 rests in the palm of the hand and are enclosed by the fingers of a user.

In said one preferred embodiment depicting a substantially oval-shaped handle region 14, a distal end 25 is defined on the handle region 14 that is distal to planar region 12. The width of the looped handle region 14 may vary by expanding from narrower to wider areas such that a variety of users may be able to grip the handle region 14 at a thickness point that is comfortable for the particular user. In one preferred embodiment, handle region 14 is approximately 0.5 inches thick and provides a comfortable grip for a user. At the point of attachment between the handle region 14 and first edge 16 and third edge 20, the width of the handle region may taper to allow a smooth transition to eliminate jagged corners or crevices in which food may become lodged during use of eating utensil 10.

In one preferred course of use, third edge 20 maintains contact with a flat surface of a substantially flat surface 27, such as a plate or a tray. However, when a concave serving dish is used, such as a bowl, distal end 25 allows for gripping the utensil using the thumb and forefinger, such that fourth edge 22 may be the leading edge of the utensil in making contact with the surface of the serving dish to push food onto another utensil. In a preferred embodiment, fourth edge 22 is substantially rounded; however, it is to be understood that fourth edge 22 may be formed of other shapes and for purposes of illustration, but not limitation, it could be pointed or squared.

The gracefully contoured oval shape of the handle region 14 is considered by the inventors to be one of the best modes of carrying out the invention because it has proven to fit comfortably within the hand of a variety of users with varying hand sizes. Of course, other shapes of the handle portion may be selected depending upon the intended ultimate use of utensil 10.

For purposes of illustration, but not limitation, a second preferred embodiment is presented in FIG. 2. The handle region 14 is attached to first edge 16, however, the attachment point can be modified as necessary to provide for differences in ergonomic grip and may be attached at a transition point between first edge 16 and third edge 20. The handle region 14 has a first end 26 and an opposing second end 28 that are interconnected by middle region 30. Middle region 30 is curved outwardly such that an area closer to the second end 28 rests between the thumb and palm of a user, and the forefinger and thumb of the user may wrap around the middle region at a location more proximal to the first end 26, such that the middle region 30 rests substantially on the first dorsal web space defined between the first and second metacarpal bones of the hand. In such engagement, the wrist of a user is maintained in a straight alignment, thereby reducing the risk of carpal tunnel syndrome, during which the second edge 18 maintains contact with flat surface 27.

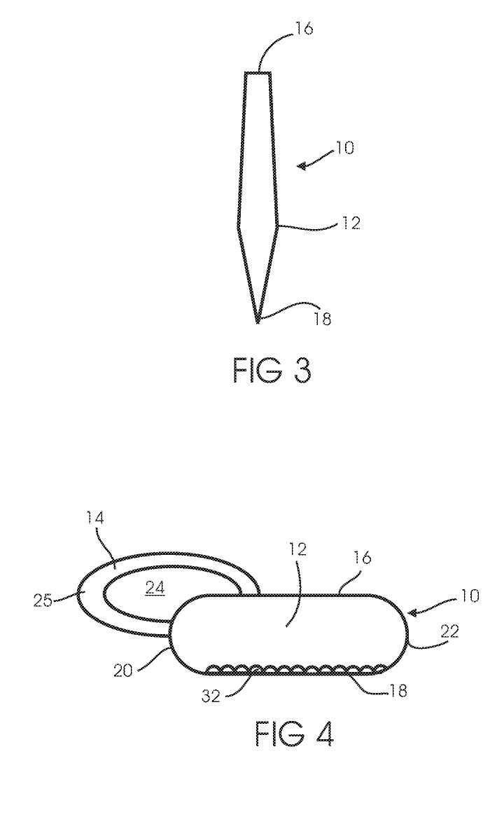

Now referring to FIG. 3, in one preferred embodiment, second edge 18 may be of narrower width than first edge 16. In such preferred embodiment, second edge 18 tapers to provide a sharp edge with possible use in cutting any food products. However, in an alternate preferred embodiment contemplated for use by children, second edge 18 does not taper in order to avoid the sharp edge that may cut a younger user. Now also referring to FIG. 4, second edge 18 may have multiple cavities 32 in order to form a serrated edge. The multiple cavities 32 may also extend to fourth edge 22 in order to allow cutting food products when eating utensil 10 is held at distal end 25.

As previously mentioned, utensil 10 of the present invention preferably is injection molded to have a single piece plastic structure. The utensil 10 may be molded from any of a variety of plastic materials as appropriate to its intended final use. For example, a polyethylene or Teflon material might be preferred if the utensil is to be used in the kitchen because of the durability of these materials and their tendency not to break and not to leach polymers or chemicals into food. Other materials such as PVC or ABS plastic also may be appropriate.

Although injection molding is the preferred fabrication method, the utensil 10 may be fabricated by other techniques such as by being formed from individual component pieces of different materials. For example, the utensil 10 may be formed with a separate metal planar region 12 fitted into plastic handle region 14, where the intended use requires rugged construction and durability. Thus, while a unitary molded plastic construction is preferred, it certainly is not required and should not be considered to be a limitation of the invention.

While the above description contains many specificities, these should not be construed as limitations on the scope of the invention, but rather as an exemplification the preferred embodiments thereof. Many other variations are possible without departing from the essential spirit of this invention. Accordingly, the scope of the invention should be determined not by the embodiments illustrated, but by the appended claims and their legal equivalents.

What is claimed is:

1. An eating utensil device for pushing food, comprising:
a planar region and a handle region emanating from said planar region;
a first end and a second end defined on said handle regions and the first end and second end being distal to one another, wherein the first end and second end are in contact with said planar region
an opening defined by the handle region.

2. The device of claim 1, wherein the device is manufactured from a unitary piece.

3. The device of claim 1, wherein the handle region has a varying width along a length thereof.

4. The device of claim 3, wherein handle region has a width of 0.5 inches.

5. The device of claim 1, wherein said planar region further comprises a first edge and an opposing second edge, a third edge and a opposing fourth edge interconnecting the first and second edges in a substantially parallel manner.

6. The device of claim 5, wherein said second edge tapers to define a sharp edge for cutting.

7. The device of claim 5, wherein said second edge is serrated to allow said second edge to cut food products.

8. The device of claim 1, wherein said first end emanates from said first edge and said second end emanates from said third edge to define said opening.

9. The device of claim 8, wherein a distal end is defined at a point on said handle region that is distal to the planar region, whereby the distal end can be engaged by the hand of a user to allow contact between fourth edge and a surface.

10. The device of claim 9, wherein the handle region has a varying width along a length thereof.

11. The device of claim 9, wherein the handle region has a width of approximately 0.5 inches.

12. The device of claim 9, wherein said planar region further comprises a first edge and an opposing second edge, a third edge and a opposing fourth edge interconnecting the first and second edges in a substantially parallel manner.

13. The device of claim 12, wherein said second edge tapers to define a sharp edge for cutting.

14. The device of claim 12, wherein said second edge is serrated to allow said second edge to cut food products.

15. An utensil device for pushing and shoveling food from a surface, comprising:
a substantially planar region;
a handle region having a first end and an opposing second interconnected by a middle region;
said first end emanating from said planar region;
said middle region being substantially curved to allow said middle region to rest on a first dorsal web region of a user's hand.

16. The device of claim 15, wherein said planar region further comprises a first edge and an opposing second edge, a third edge and a opposing fourth edge interconnecting the first and second edges in a substantially parallel manner.

17. The device of claim 16, wherein said first end of the handle region attaches to the first edge to allow the second, third, and fourth edges to contact the surface.

18. The device of claim 17, the handle region has a varying width along a length thereof.

19. The device of claim 18, wherein the utensil is made of injection molded plastic.

20. An eating utensil device for pushing food on a surface, comprising:
a planar region and a handle region emanating from said planar region;
a first edge and an opposing second edge, a third edge and a opposing fourth edge interconnecting the first and second edges in a substantially parallel manner to define said planar region;
a first end and an opposing second end defined on the handle region; and the first end and second end being distal to one another, wherein the first end and second end connect to said planar region to form an opening through the handle region to receive fingers of a user;
said handle region being approximately 0.5 inches thick.
